(19) United States
(12) Patent Application Publication
(10) Pub. No.: US 2017/0111532 A1
(43) Pub. Date: Apr. 20, 2017

(54) REAL-TIME PROCESSING OF VIDEO STREAMS CAPTURED USING MOBILE DEVICES

(71) Applicant: Kofax, Inc., Irvine, CA (US)

(72) Inventors: Jan W. Amtrup, Silver Spring, MD (US); Jiyong Ma, San Diego, CA (US); Stephen Michael Thompson, Oceanside, CA (US); Alexander Shustorovich, Pittsford, NY (US); Christopher W. Thrasher, Rochester, NY (US); Anthony Macciola, Irvine, CA (US)

(21) Appl. No.: 15/396,306

(22) Filed: Dec. 30, 2016

Related U.S. Application Data
(63) Continuation-in-part of application No. 15/339,789, filed on Oct. 31, 2016.
Application No. 15/339,789 is a continuation of application No. 13/740,141, filed on Jan. 11, 2013, now Pat. No. 9,514,357.
Application No. 13/740,141 is a continuation-in-part of application No. 14/981,759, filed on Dec. 28, 2015, now Pat. No. 9,584,729.
Application No. 14/981,759 is a continuation of application No. 14/473,950, filed on Aug. 29, 2014, now Pat. No. 9,253,349.
Application No. 14/473,950 is a continuation of application No. 14/268,876, filed on May 2, 2014, now Pat. No. 8,885,229.
(60) Provisional application No. 61/720,958, filed on Oct. 31, 2012.
(60) Provisional application No. 61/586,062, filed on Jan. 12, 2012.
(60) Provisional application No. 61/819,463, filed on May 3, 2013.

(51) Int. Cl. H04N 1/00; H04N 5/232; G06K 9/46; H04W 4/02; G06K 9/62

(52) U.S. Cl. CPC H04N 1/00801; H04W 4/02; G06K 9/6267; G06K 9/46; H04N 5/23206; H04N 5/23222; H04N 1/00251; H04N 1/00244; G06K 9/18

(57) ABSTRACT

The presently disclosed inventive concepts encompass capturing video data using a mobile device, streaming the captured video data to a server for processing of the video data in real-time or near-real time, and providing the server's processing result to the mobile device for additional analysis and/or processing of the captured video data, the processing result, or both. In one embodiment an image processing server is configured to: process, in real time, input streamed to the server from a mobile device, the input comprising one or more frames of digital video data; and output a result of processing the input to the mobile device. In another embodiment, a method includes capturing video data using a mobile device, streaming the video data to an image processing server, receiving a processing result from the server, and further processing the captured video data and/or the processing result using the mobile device.

### RELATED APPLICATIONS

The presently disclosed inventive concepts are related to, and may be used in conjunction with, a host of image processing features, functions, and techniques including, but not limited to, object detection as disclosed in U.S. Pat. No. 8,855,375, filed Jan. 11, 2013; and U.S. Pat. No. 9,208,536, filed Sep. 19, 2014; U.S. patent application Ser. No. 14/927,359, filed Oct. 29, 2015; Ser. No. 15/234,969, filed Aug. 11, 2016 and Ser. No. 15/234,993, filed Aug. 11, 2016; rectangularization; illumination problem detection; illumination normalization; blur detection; and resolution estimation as also disclosed in U.S. Pat. No. 8,855,375, filed Jan. 11, 2013; binarization as disclosed in U.S. patent application Ser. No. 15/214,351, filed Jul. 19, 2016 and Ser. No. 15/396,327, filed Dec. 30, 2016, object classification as disclosed in U.S. Pat. No. 9,355,312, filed Mar. 13, 2013 and/or U.S. patent application Ser. No. 14/177,136, filed Feb. 10, 2014; data extraction as disclosed in U.S. Pat. No. 9,311,531, filed Mar. 13, 2015; video processing as disclosed in U.S. Pat. No. 8,885,229, filed May 2, 2014; long document processing and composite image generation as disclosed in U.S. Pat. No. 9,386,235, filed Nov. 14, 2014; context-dependent workflow invocation as disclosed in U.S. Pat. No. 9,349,046, filed Apr. 14, 2015; and data validation as disclosed in U.S. Pat. No. 8,345,981, filed Feb. 10, 2009; Ser. No. 8,774,981, filed Nov. 12, 2013; Ser. No. 8,958,605, filed Feb. 7, 2014; and U.S. patent application Ser. No. 15/146,848, filed May 4, 2016; and Ser. No. 14/804,278, filed Jul. 20, 2015. The contents of each of the foregoing patents and applications are hereby incorporated by reference.

### FIELD OF INVENTION

The present invention relates to image processing. In particular, the present invention relates to capturing and processing full frame rate streams of digital video data using a mobile device and/or remote server in real-time.

### BACKGROUND OF THE INVENTION

Mobile applications for image processing remain an integral component to many business applications, particularly financial transactions. At the introduction of mobile device-based image processing and related applications, many technologies generally relied on the mobile device as the component utilized to capture still image data. The image data were then transmitted to a remote processing device, e.g. to a server, since processing power of the mobile devices were insufficient to perform the necessary analysis (e.g. detecting a document depicted in the image, and/or extracting text via optical character recognition) and/or modification of the image data (e.g. converting images to grayscale or bitonal renderings of color image data).

As mobile device technology improved, particularly with respect to processing power, it has become feasible to perform certain analyses and/or modifications of still image data directly using the mobile device. This conveys the advantage of reducing data consumption and bandwidth required to accomplish certain analyses and/or modifications, but is limited to processing of still images. Moreover, depending on the complexity of the analysis/modification operation(s), the processes may require significant execution time (e.g. several seconds, which is unacceptable for many users and precludes the ability to timely process video streams which typically exhibit a frame rate of 30 frames per second, imposing a processing time limitation of approximately 1/30 seconds to enable processing of the full stream in real-time).

As such, requisite image processing analyses and modifications have been inapplicable to video data due to the processing power limitations of the mobile device. Using video streams rather than still images as the input to the processing workflows is advantageous because many times the still image is captured under less-than-ideal circumstances, resulting in artifacts such as blur, insufficient illumination, perspective distortion, etc. As a result, the user is often required to repeat the capture operation, which is inconvenient at best, and impossible in some cases (e.g. where the subject of the originally-captured image is no longer available to the user). By using a video stream as input, the user may simply initiate a capture operation, and the best available frame(s) may be utilized for subsequent processing, optimizing the quality of the input and convenience for the user.

However, as noted above, processing power is not currently sufficient to enable real-time image processing directly on the mobile device. Indeed, the energy requirements necessary to provide sufficient processing power to perform image processing in real-time on video streams is unlikely to be realized on mobile devices without a revolution in processor design and function. As such, some solutions which currently utilize video input effectively sample a subset of the video frames and perform image analysis thereon. However, this sampling creates a “lag” between the real-time video input received by the camera and the result of the analysis. For instance, attempting to detect an object such as a document is difficult using such techniques since, by the time the location of the document is estimated from the analyzed frame, the camera has moved (and thus the position of the document in the video is different than the predicted location determined by analyzing the prior frame). In order to avoid such lag, it is necessary to enable processing of full frame-rate video streams, preferably in real-time.

Accordingly, it would be advantageous to provide systems and techniques for real-time video stream processing to enable expansion of many useful applications to video input.

### SUMMARY OF THE INVENTION

In one embodiment, an image processing server includes at least one processor, and logic configured, upon execution thereof by the processor(s), to cause the server to: process, in real time, input streamed to the server from a mobile device, the input comprising one or more frames of digital video data; and output a result of processing the input to the mobile device.

In another embodiment, a computer-implemented method includes: capturing, using a camera of a mobile device, a plurality of frames of digital video data; streaming at least some of the plurality of frames of digital video data to an image processing server configured to process frames of digital video data in real-time; receiving, from the image processing server, a processing result corresponding to some or all of the plurality of frames of digital video data streamed to the image processing server; and further processing, using a processor of the mobile device, according to one or more predetermined additional processing operations, some or all of the plurality of frames of digital video data captured using the camera of the mobile device, the processing result received from the image processing server, or both.

In yet another embodiment, a computer program product includes a computer readable medium having embodied therewith computer readable program code. The computer readable program code is configured, upon execution thereof, to cause a mobile device to perform operations including: capturing, using a camera of the mobile device, a plurality of frames of digital video data; streaming at least some of the plurality of frames of digital video data to an image processing server configured to process frames of digital video data in real-time; receiving, from the image processing server, a processing result corresponding to some or all of the plurality of frames of digital video data streamed to the image processing server; and further processing, using a processor of the mobile device and according to one or more predetermined additional processing operations, some or all of the plurality of frames of digital video data captured using the camera of the mobile device, the processing result received from the image processing server, or both.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 is a flowchart of a method, according to one embodiment.

FIG. 4 is a flowchart of a method, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The present application refers to image processing of images (e.g. pictures, figures, graphical schematics, single frames of movies, videos, films, clips, etc.) captured by cameras, especially cameras of mobile devices. As understood herein, a mobile device is any device capable of receiving data without having power supplied via a physical connection (e.g. wire, cord, cable, etc.) and capable of receiving data without a physical data connection (e.g. wire, cord, cable, etc.). Mobile devices within the scope of the present disclosures include exemplary devices such as a mobile telephone, smartphone, tablet, personal digital assistant, iPod®, iPad®, BLACKBERRY® device, etc.

However, as it will become apparent from the descriptions of various functionalities, the presently disclosed mobile image processing algorithms can be applied, sometimes with certain modifications, to images coming from scanners and multifunction peripherals (MFPs). Similarly, images processed using the presently disclosed processing algorithms may be further processed using conventional scanner processing algorithms, in some approaches.

Of course, the various embodiments set forth herein may be implemented utilizing hardware, software, or any desired combination thereof. For that matter, any type of logic may be utilized which is capable of implementing the various functionality set forth herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, processor, or device.

A computer readable signal medium may include a propagated data signal with computer readable program code embodied therein, for example, in baseband, as part of a carrier wave, an electrical connection having one or more wires, an optical fiber, etc. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

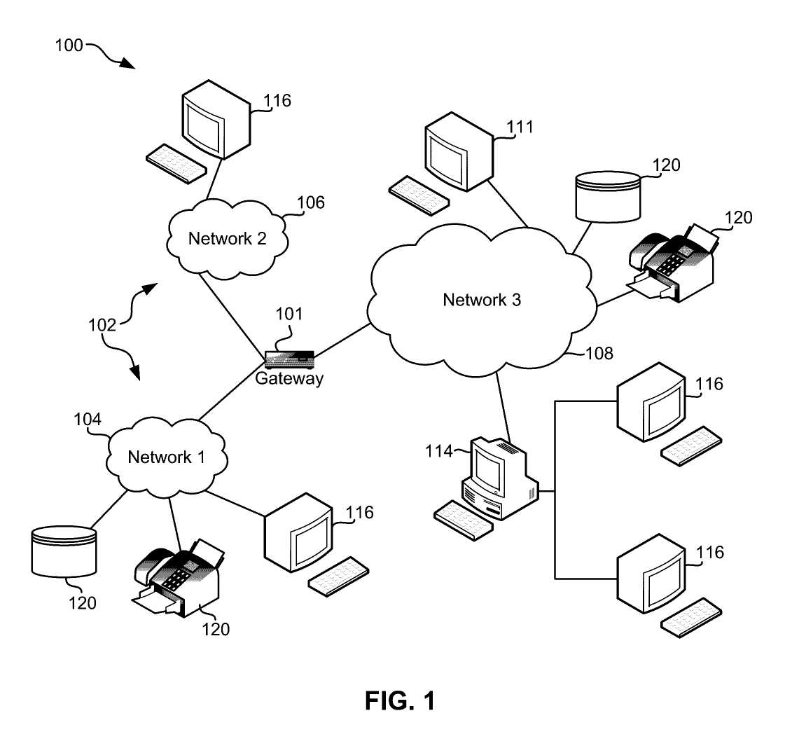

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

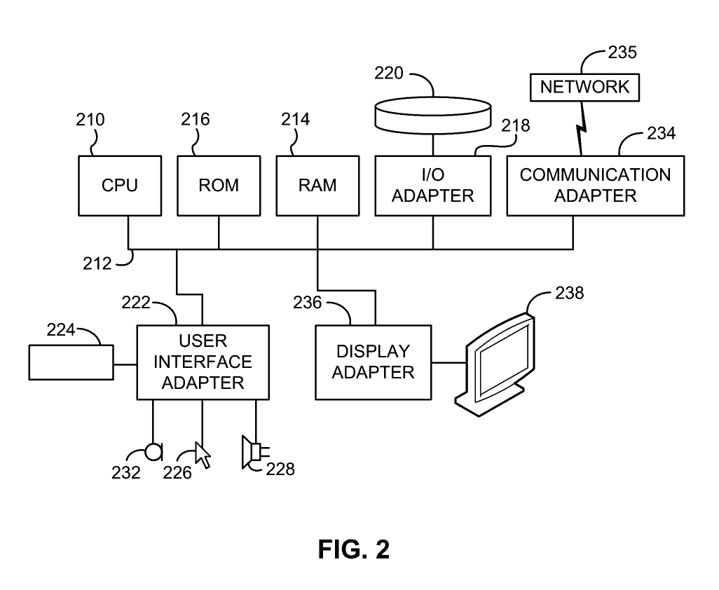

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

An application may be installed on the mobile device, e.g., stored in a nonvolatile memory of the device. In one approach, the application includes instructions to perform processing of an image on the mobile device. In another approach, the application includes instructions to send the image to a remote server such as a network server. In yet another approach, the application may include instructions to decide whether to perform some or all processing on the mobile device and/or send the image to the remote site.

It will further be appreciated that embodiments presented herein may be provided in the form of a service deployed on behalf of a customer to offer service on demand

Video Stream Processing

In general, the presently disclosed inventive concepts encompass the notion of capturing video data using a mobile device, streaming the captured video data to a server for processing of the video data in real-time or near-real time, and providing the server's processing result to the mobile device for additional analysis and/or processing of the captured video data, the processing result obtained by the server, or both.

Accordingly, in one general embodiment, an image processing server includes at least one processor, and logic configured, upon execution thereof by the processor(s), to cause the server to: process, in real time, input streamed to the server from a mobile device, the input comprising one or more frames of digital video data; and output a result of processing the input to the mobile device.

In another general embodiment, a computer-implemented method includes: capturing, using a camera of a mobile device, a plurality of frames of digital video data; streaming at least some of the plurality of frames of digital video data to an image processing server configured to process frames of digital video data in real-time; receiving, from the image processing server, a processing result corresponding to some or all of the plurality of frames of digital video data streamed to the image processing server; and further processing, using a processor of the mobile device, according to one or more predetermined additional processing operations, some or all of the plurality of frames of digital video data captured using the camera of the mobile device, the processing result received from the image processing server, or both.

In yet another general embodiment, a computer program product includes a computer readable medium having embodied therewith computer readable program code. The computer readable program code is configured, upon execution thereof, to cause a mobile device to perform operations including: capturing, using a camera of the mobile device, a plurality of frames of digital video data; streaming at least some of the plurality of frames of digital video data to an image processing server configured to process frames of digital video data in real-time; receiving, from the image processing server, a processing result corresponding to some or all of the plurality of frames of digital video data streamed to the image processing server; and further processing, using a processor of the mobile device and according to one or more predetermined additional processing operations, some or all of the plurality of frames of digital video data captured using the camera of the mobile device, the processing result received from the image processing server, or both.

The processing performed by the server is preferably a type of processing for which real-time results cannot be obtained using the limited processing power of a mobile device, exemplars of which include the some of the techniques disclosed in the various patent documents incorporated hereinabove by reference. In particularly preferred approaches, it should be understood that exemplary types of processing not capable of completion in real-time using a mobile device include but are not limited to content-based detection as disclosed in U.S. patent application Ser. No. 15/234,969, filed Aug. 11, 2016 and Ser. No. 15/234,993, filed Aug. 11, 2016, and data extraction (particularly when extraction involves or is followed by iterative OCR, e.g. as disclosed in U.S. patent application Ser. No. 15/214,351, filed Jul. 19, 2016). In some embodiments, depending on the complexity of the data and knowledge bases, data validation may qualify as a type of processing not capable of real-time performance using a mobile device.

Even for techniques capable of being performed on the mobile device, such as those not specifically mentioned directly above but disclosed in the related patent applications incorporated by reference hereinabove, streaming video to a server for processing using the server's superior hardware enables improved performance of the associated techniques because processing results may be achieved more quickly than using the mobile device's limited processing power, and more importantly because the video stream allows consensus building and consequential improvements to the final result of processing, as described in greater detail below.

Accordingly, in preferred implementations the presently disclosed inventive concepts represent an improvement to the function of image processing systems by enabling real-time processing of video data, which conveys particular advantages in terms of processing result accuracy and confidence (see descriptions below regarding consensus building, for example) without the detrimental delays associated with attempting similar processing using a mobile device alone. Indeed, in various implementations the processing time required using a mobile device prohibits the use of video data as input for the processing task, since the processing time is greater than the framerate of the video (or some fraction of the framerate, such as a processing time in excess of three times the frame rate, or 1/10 second for most video capture devices which operate at 30 frames per second).

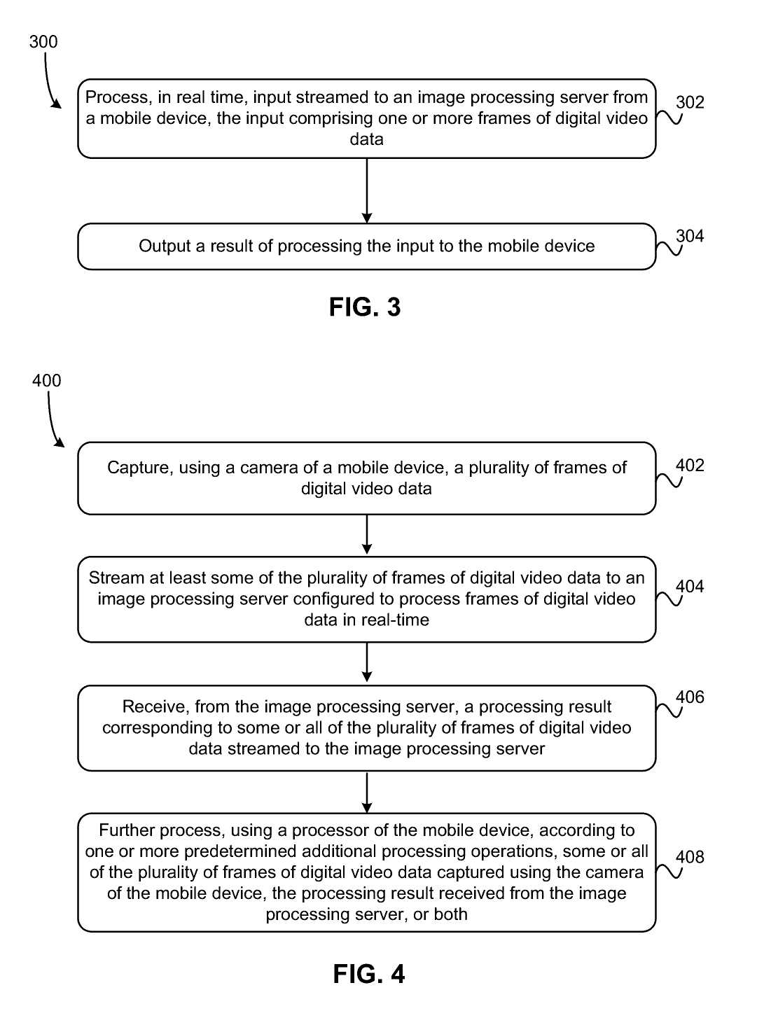

Now referring to FIG. 3, a flowchart of a method 300 is shown according to one embodiment. The method 300 may be performed in accordance with the present invention in any of the environments depicted in FIGS. 1-2, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by an image processing server, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where the server processes input streamed from the mobile device. The input includes one or more frames of digital video data, and the processing of the input is performed by the server in near real-time or in real-time.

In operation 304, method 300 includes outputting a result of processing the input. The result may be output in any suitable fashion, and is output in a manner so that the processing result is transmitted to the mobile device that streamed the input to the server, e.g. via a network. In other embodiments, the

As will be described in further detail below regarding FIG. 4 and method 400, the mobile device may subsequently perform additional actions utilizing the processing result, allowing the performance of a host of image processing operations and associated downstream workflows (e.g. check deposit, driver license renewal, bill payment, patient or client intake, insurance claims processing, etc. without limitation and as would be appreciated by a skilled artisan upon reviewing the present disclosures) in near- or real-time, and all without requiring the user to ever manually capture an image of the relevant subject matter. Avoiding this manual capture procedure represents an improvement to the function of image processing devices and associated processing techniques, particularly when utilized in combination with the inventive consensus-building approach described in further detail below. In brief, avoiding manual capture and enabling real-time processing (or near real-time) achieves a more accurate processing result using less computational resources than would be necessary if attempting to achieve an equivalent result using conventional, non-real time processing.

The method 300 is not limited to operations 302-304, but rather may include or leverage a number of additional or alternative features all falling within the scope of a single inventive embodiment as shown and described with reference to FIG. 3. For instance, according to various aspects of this inventive embodiment, method 300 may include, or leverage, any combination, permutation, or synthesis of the following features, functions, and operations.

Moreover, the method 300 may be supplemented with additional processing such as described in any one or more of the patents and/or patent applications incorporated by reference hereinabove. In particularly preferred embodiments, method 300 may include additional processing including but not limited to: (1) object detection as disclosed in U.S. Patent No. 8,855,375, filed Jan. 11, 2013; and U.S. Pat. No. 9,208,536, filed Sep. 19, 2014; U.S. patent application Ser. No. 14/927,359, filed Oct. 29, 2015; Ser. No. 15/234,969, filed Aug. 11, 2016 and Ser. No. 15/234,993, filed Aug. 11, 2016; (2) object classification as disclosed in U.S. Pat. No. 9,355,312, filed Mar. 13, 2013 and/or U.S. patent application Ser. No. 14/177,136, filed Feb. 10, 2014; (3) data extraction (optionally including binarization or thresholding as described in U.S. patent application Ser. No. 15/2314,351, filed Jul. 19, 2016 and Ser. No. 15/396,327, filed Dec. 30, 2016) as disclosed in U.S. Pat. No. 9,311,531, filed Mar. 13, 2015; and/or (4) data validation as disclosed in U.S. Pat. No. 8,345,981, filed Feb. 10, 2009; U.S. Pat. No. 8,774,981, filed Nov. 12, 2013; U.S. Pat. No. 8,958,605, filed Feb. 7, 2014; and U.S. patent application Ser. No. 14/804,278, filed Jul. 20, 2015.

One aspect of the embodiment of FIG. 3 includes the notion that the input comprises a plurality of the frames of digital video data. Processing the input includes one or more of several functions. For instance, processing the input may include transforming a representation of an object depicted in the plurality of frames of digital video data from a native object representation to an improved object representation, e.g. using a four-point algorithm to detect and transform objects using corner positions as described in U.S. Pat. No. 9,208,536, filed Sep. 19, 2014 or detect and transform objects using internal feature positions as described in U.S. patent application Ser. No. 14/927,359, filed Oct. 29, 2015; Ser. No. 15/234,969, filed Aug. 11, 2016 and Ser. No. 15/234,993, filed Aug. 11, 2016.

A native object representation may be understood as the representation of the object as appearing in the captured video frame (e.g. a frame depicting an object, but said object's location or existence within the image not having been detected; a frame depicting the object according to a warped perspective or a skewed angle; a frame depicting the object under poor illumination such as a shadow, low-contrast lighting, etc.; a frame depicting a blurred representation of the object or a cut-off representation of the object, etc. as would be understood by a person having ordinary skill in the art upon reading the present descriptions. Conversely, an improved object representation may be understood as the representation of the object after processing frame(s) depicting the native object representation. For instance, an improved object representation may include a bounding line, border, box, etc. surrounding a detected object in the processed frame(s); a rectified or rectangularized representation of the object; a deskewed, cropped, illumination-normalized, or binarized representation of the object, a composite image of the object generated from two or more of the video frames, etc. as would be appreciated by a person having ordinary skill in the art upon reading the present disclosures.

More generally, objects depicted according to native representation may be understood as including one or more defects or challenges as disclosed in the related patent applications incorporated hereinabove, while objects depicted according to an improved representation may be understood as excluding such defects or having solved such challenges.

With continuing reference to FIG. 3 and method 300, processing the input using the server may include determining information of interest regarding the object from the plurality of frames of digital video data, e.g. an object classification, presence of particular information of interest such as text, validating content of the object, etc. in various approaches. Preferably, information of interest are determined from one or more transformed frames depicting the object according to the improved representation thereof).

For instance, in one approach the object as represented in the transformed/improved representation/frame/etc. may be classified, and representative features (e.g. position of text or other elements of interest, color characteristics of foreground and/or background, etc.) may be determined based on the classification of the object. Classification may be performed according to the techniques disclosed in U.S. Pat. No. 9,355,312, filed Mar. 13, 2013 and/or U.S. patent application Ser. No. 14/177,136, filed Feb. 10, 2014, in various embodiments.

Further still, processing the input may include extracting some or all of the information of interest regarding the object from the plurality of frames of digital video data. Again, preferably, information are extracted from one or more transformed frames depicting the object according to the improved representation thereof. Extracted information may include text, image features, object features, etc. as will be appreciated by skilled artisans upon reading the instant disclosures and descriptions from related patent applications incorporated hereinabove by reference. Data extraction may be performed according to the techniques generally described in U.S. Pat. No. 9,311,531, filed Mar. 13, 2015, optionally including improved binarization as disclosed in U.S. patent application Ser. No. 15/2314,351, filed Jul. 19, 2016 and Ser. No. 15/396,327, filed Dec. 30, 2016.

To facilitate such processing, the input may not be limited to the captured video frames, but may optionally include identifying information corresponding to the mobile device. For instance, such identifying information may be useful in validation of extracted information, and may include a mobile phone immutable identifier e.g. as described in further detail in the related patent applications incorporated by reference hereinabove. The input may additionally or alternatively include intrinsic capture device parameters, additional sensor data from the capture device (e.g. motion vectors associated with device movement during video capture, location information corresponding to capture location, audio input from a user describing the subject of the video stream or other relevant information related to the video capture, etc. as would be understood by a person having ordinary skill in the art upon reading the present descriptions, including the subject matter of the patent documents incorporated herein by reference.) These additional inputs are useful in various contexts, including but not limited to content-based detection of objects and 3D reconstruction of digital image and video data, e.g. as described in further detail in the related patent documents incorporated by reference hereinabove.

Further still, input may include user-defined processing parameters, e.g. predefined instructions defining the appropriate processing operations to be performed on the server such as the additional processing mentioned hereinabove and described in detail in the related patent documents incorporated herein by reference, parameters or preferences for such processing operations, etc. as would be understood by a person having ordinary skill in the art upon reading the present descriptions and as described in further detail in the related patent applications incorporated by reference hereinabove. For example, generally speaking the user predefining the type (class) of document to be processed enables more accurate, and/or faster (less computationally expensive) processing since the relevant transformations/manipulations of the document may be tailored based on a-priori knowledge regarding features of documents belonging to the predefined class.

Input streamed to the server with the video data may optionally further include location information corresponding to the mobile device, the one or more frames of digital video data, or both. Without limitation, such information is useful for disambiguating classification results based on location, for determining appropriate formatting of extracted information based on location, etc. as would be appreciated by a skilled artisan upon reviewing the instant disclosure, etc. as described in further detail in the related patent applications incorporated by reference hereinabove, including but not limited to U.S. patent application Ser. No. 14/177,136, filed Feb. 10, 2014.

Accordingly, processing the input may optionally include processing the one or more frames of digital video data further based at least in part on the identifying information, the user-defined processing parameters, and/or the location information, in various approaches of the embodiment depicted in FIG. 3.

The server preferably processes each one of the one or more frames of the digital video data streamed to the server from the mobile device in real-time, or near real-time. In various embodiments, processing the digital video data may involve processing each individual frame, or processing a subset of the frames (e.g. every other frame or every third frame). In practice, the delay between video frames is typically about 1/30 seconds (i.e. a typical frame rate at the time of filing this application is approximately 30 frames per second (fps)). As will be appreciated by persons having ordinary skill in the art upon reading these disclosures, it is critical for processing to be completed within an amount of time ideally less than the amount of time that elapses between capturing successive frames of the video data. This is preferred because processing times in excess of this “gap” result in a processing lag that quickly renders the processing result erroneous.

For instance, in the context of detecting an object depicted within video data, if the camera or object are in motion relative to one another, the appearance of the object (e.g. location, size, warping, etc.) may change from frame to frame, perhaps drastically. This means that processing the video frames to detect the object is only informative if the detection process may be accomplished in an amount of time with sufficiently low “lag” to correspond to the actual location of the object within the video frame most recently captured by the camera. If processing takes longer than the amount of time between successive frames, it is likely the processing result will not be accurate or even applicable to the real-time display on the mobile device. Of course, skilled artisans will appreciate that other variables relating to image capture, such as illumination, etc. may change from frame-to-frame, complicating the processing of video data in a manner that is relevant to the real-time display seen on the mobile device. Accordingly, the presently disclosed inventive concepts may include using the server to compute the location of an object within various frames of a video stream, effectively “tracking” the object throughout the stream, and providing the computed location within the stream to the mobile device. Tracking may be accomplished, in various embodiments, according to the techniques described in U.S. Pat. No. 9,386,235, filed Nov. 14, 2014.

In some embodiments, it may be acceptable to expand the processing time to encompass the amount of time elapsed between capturing two or three successive frames of video data, e.g. because the amount of motion, change in lighting, etc. may be sufficiently small such that any “lag” associated with the processing is within tolerable limits. Exemplary time frames in which such lag may be tolerable are generally delays of about 1/10 seconds or less (or other delays corresponding to capture of about 3 frames of video data according to the video capture frame rate of the capture device).

Notably, the foregoing descriptions of processing time rest on the assumption that processing is the rate-limiting portion of the overall workflow set forth herein. Accordingly, skilled artisans will understand that the foregoing exemplary scenarios assume sufficient network bandwidth and speed that transmission of video frames and/or other optional information from the mobile device to the server, as well as transmission of processing results from the server (via a network, e.g. as shown in FIG. 1) is negligible. At very least the time associated with transmitting information between the server and mobile device (or other client device), coupled with the processing time, should be less than the amount of time that elapses between no more than four, preferably no more than three, and most preferably no more than two successive frames of the video data.

Put another way, in practical implementation five variables contribute to the time associated with capturing, transferring, and processing data using a mobile device and server in combination as proposed herein. These include: upstream lag (the amount of time that the signal needs to reach the server form the mobile device); data transfer throughput or bandwidth (how much data can be streamed per second to the server); (3) video encoding; (4) processing time on the server; and (5) downstream lag, which is a measure of how much time elapses between the server reaching a result/decision and the user being informed of the result/decision.

Among these, in the context of the presently described inventive concepts, (2) data transfer throughput and (4) server processing time are most critical, as low throughput reduces the amount of data available for analysis (and concurrent advantages associated with e.g. confidence-analysis and consensus building as described in further detail below) and high server processing time essentially forces a similar result in the form of dropping frames from the analysis within the processing window. Also important, but not critical, are (3) video encoding and (5) downstream lag, which may cause delays in processing but are less likely to result in loss of information (e.g. dropped/unstreamed frames).

In several implementations, processing time, and any associated transmission time, should therefore be less than about 1/10 seconds, preferably less than about 1/15 seconds, and most preferably less than about 1/30 seconds. The foregoing exemplary time frames assume a capture device having a conventional 30 fps frame rate for video capture. Skilled artisans reading the present disclosure will appreciate that other intervals may apply in embodiments where the capture device has a different frame rate (e.g. 24 fps, 60 fps, etc.). However, it will be readily apparent the appropriate intervals that may be tolerated for a given capture device based on the frame rate and nature of the processing operation.

In any event, skilled artisans will also glean from these disclosures that a server or equivalently powerful processing device, environment, etc. is a critical component of enabling the presently disclosed real-time processing of video data. Mobile devices such as mobile phones, cameras, tablets, and other hand-held or similar scale technology simply lack the processing power necessary to perform useful image processing operations such as object detection, object classification, image rectification, binarization, etc. at sufficient speeds to avoid the detrimental or prohibitive lag described above. Indeed, due to size and power restrictions inherent to mobile devices and existing energy storage technology, it is unlikely that mobile devices will achieve sufficient processing power to enable real-time processing of video data.

For instance, in the context of content based document detection such as disclosed in U.S. patent application Ser. No. 15/234,969, filed Aug. 11, 2016 and Ser. No. 15/234,993, filed Aug. 11, 2016 using current state-of-the-art mobile device technology performing content-based document detection takes on the order of several seconds, e.g. 2-3 seconds, for a still image as input.

As disclosed in U.S. patent application Ser. No. 15/234,969, filed Aug. 11, 2016 and Ser. No. 15/234,993, filed Aug. 11, 2016, content-based detection involves capturing an image that depicts a document such as an ID card in a contextually relevant situation (e.g. context including the type of capture device used to capture the image), and applying content based detection to analyze the contextual information, detect the document, and crop the image to remove background. However, this is not presently feasible when the input is a video stream, because 2.5 seconds for each iteration of the analysis is simply too slow. Accordingly, streaming video frames to a server, e.g. with a rate of 10 frames per second, where the server would be able to analyze each of those frames in 1/10 of a second or faster using those context mechanisms, then the context analysis may be performed by the server in real-time or near-real time, omitting the need for a manual step of taking a picture. This, in turn, enables capturing documents such as IDs automatically under all kinds of very difficult backgrounds.

Another exemplary process that cannot be performed currently using video streams as input is optical character recognition (OCR), and particularly iterative, recognition guided thresholding as disclosed in U.S. patent application Ser. No. 15/214,351, filed Jul. 19, 2016; and/or Sere. No. 15/396,327, filed Dec. 30, 2016.

Accordingly, as understood herein, “near real-time” processing of video data means the amount of time required to complete a given processing operation on a given frame of the video data is less than or equal to the amount of time that elapses between capturing no more than four successive frames of the video data (where the first frame capture corresponds to time point zero). “Real-time” processing of video data means the amount of time required to complete a given processing operation on a given frame of the video data is less than or equal to the amount of time that elapses between capturing two successive frames of the video data (where the first frame capture corresponds to time point zero). In a particularly preferred embodiment, “real-time” processing refers to processing each of a plurality (e.g. ten or more) of successive frames of video data in an amount of time less than the amount of time between capturing any two of the plurality of successive frames of video data.

As will be described in further detail below, processing digital video data in near real-time (and to a greater extent, in real-time) allows maximal bootstrapping between the processing results achieved for various frames, thereby allowing an evaluation of the confidence in any particular processing result, and/or building consensus processing results from among the various individual frame processing results. This bootstrapping process improves the function of image processing devices by ensuring a high-confidence processing result is output, rather than simply processing a single, e.g. a first or selected, frame of the video data, and outputting the result of processing only that single frame.

For instance, if a video stream subject to OCR processing includes ten frames each depicting twenty characters, and each of these ten frames are processed, ten OCR results are obtained. If all ten OCR results agree on eighteen characters, while eight of the ten results agree on the remaining two characters, then one may conclude with high confidence that the most likely result is the one including the eighteen characters with perfect agreement, and the two characters with 80% agreement. As will be appreciated by skilled artisans, the first or a particular chosen frame analyzed in solitude may have produced the disagreeing result(s) regarding the two potentially ambiguous characters. Accordingly, an incorrect result obtained using only one, or a small number of processing attempts may be avoided or rectified by building a consensus among various results and selecting/building an overall processing result based on the consensus.

Again, skilled artisans will appreciate that the greater the number of votes (e.g. individual processing results), the greater the confidence that may be derived from the consensus. For this additional reason, it is particularly preferred that processing of the each individual video frame may be completed near real-time or real-time, since this level of “processing resolution” allows the maximum number of votes in the consensus.

Attempting to achieve this result using conventional techniques would require capturing an image, submitting the image to the server, processing the image using the processor, and storing the processing result. This procedure would need to be repeated a number of times (each repetition corresponding to an additional “vote” in the consensus) and a consensus calculated from these individual results. Since the user would need to separately capture each image, and transmit each captured image in a separate network communication, the time and cost of building consensus from individual capture results is prohibitive. For instance, since still images are generally higher resolution and therefore include more data than video, this manual approach is associated with greater consumption of network resources.

Moreover, due to the greater delay between a user-performed sequence of capture and submission operations, it is likely that much more significant differences between each image will be imparted (e.g. due to lighting change, motion of the capture device, etc.) than occur in the approximately 1/30 second between capturing successive video frames. For all these reasons, the presently disclosed inventive concepts represent a technical improvement over conventional techniques for processing image data.

Accordingly, in the context of the embodiment of method 300, processing the input may involve calculating a consensus processing result from among a plurality of processing results each respectively corresponding to one of the frames of digital video data. One exemplary version of consensus-building is disclosed in U.S. patent application Ser. No. 15/214,351, filed Jul. 19, 2016 in the context of binarization. Skilled artisans will appreciate the general principles of consensus building are applicable to a wide variety of other applications and contexts, including the functions and features of method 300 as described herein and those of the related patent applications incorporated by reference hereinabove.

In various implementations of method 300, and depending in part on the nature of the processing and importance of continuity between video frames, the input video frames may include successive frames of digital video data. Preferably, the input comprises a plurality of such successive frames, and all such frames are processed by the server. However, in alternative approaches, and to reduce network bandwidth consumption, the input may comprise alternating (e.g. every other, every third, etc.) frames of video data captured by the mobile device.

Moreover, in some approaches skipping frames of video may improve the processing result, e.g. in scenarios involving intermittent sources of interference or conditions detrimental to video capture. For example, a flickering light or passing shadow may cause transient poor image capture conditions which may be avoided by capturing video over a prolonged period of time. However, streaming and processing all frames of the video captured over the prolonged period may be unnecessary to accomplish a high-confidence processing result, and further associated with undesirable computational cost and network bandwidth usage. Accordingly, a limited number of frames may be captured during the prolonged period, with predetermined delays (e.g. 10 frames or 3 seconds for a capture device operating at 30 fps) between the capture of the selected frames. Similarly, capture device motion, orientation relative to the object that is the subject of the video capture, etc. may contribute to transient, undesirable capture conditions which may be avoided by enforcing “gaps” between the frames sent to the server for processing.

In more implementations, the amount of video data streamed to the server may be limited. For instance, the amount of video data may be limited according to an amount of network bandwidth usage permitted, number of frames sent, streaming time, etc. in various embodiments. Preferably, any limitation set on the amount of video to stream to the server is predefined based on knowledge regarding the minimum amount of data necessary to reliably achieve a desired processing result. In the exemplary context of consensus building the amount of data streamed to the server may be capped based on the number of votes needed to accomplish a result with a desired amount of confidence, which may vary depending on the type of processing and the complexity of the video data (e.g. text appearing in a video showing a document with a complex background is more difficult to reliably identify and extract, and may require more votes than a simple video showing a white document with black text depicted thereon). Accordingly, in various implementations the total amount of video data streamed to the server may be limited according to the amount of information necessary to accomplish a processing result with desired confidence.

Another major advantage and improvement in the function of image processing devices conveyed by implementing the presently disclosed inventive techniques includes avoiding the need to capture an image and submit the image for processing without confidence (or ideally, knowledge) that the result of such processing will be correct. Traditionally, image processing involves capturing image data and processing the captured image data, e.g. to improve the quality thereof, extract information therefrom, etc. as will be appreciated by a person having ordinary skill in the art upon reading the instant descriptions. This process applies even in the context of video frames as input, where typically the video data may be analyzed to ensure optimal quality, and a corresponding high-resolution image is captured upon detecting appropriate quality conditions from the video. (Notably, video typically has lower resolution than still images captured by a same capture device, so the still image is still preferable to ensure maximum information retention for subsequent processing.)

The presently disclosed inventive techniques, however, obviate the need to perform separate capture and processing operations. Instead, by leveraging the much greater processing power of the server environment, image processing may be performed directly on the video stream, and processing results generated directly therefrom. The aforementioned difference in resolution between video and still images may be overcome, e.g., via employing a consensus approach as described herein, which may include leveraging superresolution as described in U.S. Pat. No. 8,885,229, filed May 2, 2014. This reduces the burden on the user, and associated user-generated errors (e.g. improper capture device alignment, flash setting, focus, etc.) commonly introduced via manual capture. Moreover, this approach reduces the overall amount of time and processing necessary to produce an appropriate or “correct” processing result since the manual capture process need not be repeated in the event of a failure to process the initial image.

Persons having ordinary skill in the art will appreciate that the features and functions set forth above regarding FIG. 3 are representative of the features and functions conveyed by/via the image processing server, and processing of streamed video data thereby. These techniques may be used in conjunction with (and indeed are integral to) corresponding functions and features existing on the client side of the processes described herein, e.g. the mobile device, which will be described in further detail below with reference to FIG. 4.

Now referring to FIG. 4, a flowchart of a method 400 is shown according to one embodiment. The method 400 may be performed in accordance with the present invention in any of the environments depicted in FIGS. 1-2, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a mobile device such as a smartphone, tablet, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a plurality of frames of digital video data are captured using a camera of a mobile device. Preferably, the frames include successive frames, but not all such frames need necessarily be subsequently streamed to an image processing server. Rather, in some approaches alternating frames may be streamed to the image processing server.

In operation 404, at least some of the plurality of frames of digital video data are streamed, e.g. using a wireless internet connection or data plan, to an image processing server configured to process the digital video data in real-time.

In operation 406, and preferably (but not necessarily) following performance by the image processing server of a method in accordance with method 300 above, a processing result corresponding to some or all of the plurality of frames of digital video data streamed to the server is received by the mobile device.

With continuing reference to FIG. 4, method 400 includes further processing, in operation 408, some or all of the plurality of frames of digital video data captured using the camera of the mobile device, the processing result received from the image processing server, or both according to one or more predetermined additional processing operations.

Thus, in various implementations the video data streamed to the server may provide guidance for further processing the streamed video data, subsequently captured video data (e.g. where the user maintains the video capture operation during streaming, the processing result may guide the user regarding capture of additional video and/or may direct the mobile device to perform specific processing on subsequent frames of the video data), and/or the processing result itself.

The method 400 is not limited to operations 402-408, but rather may include or leverage a number of additional or alternative features all falling within the scope of a single inventive embodiment as shown and described with reference to FIG. 4. For instance, according to various aspects of this inventive embodiment, method 400 may include, or leverage, any combination, permutation, or synthesis of the following features, functions, and operations.

Moreover, the method 400 may be supplemented with additional processing such as described in any one or more of the patents and/or patent applications incorporated by reference hereinabove. In particularly preferred embodiments, method 400 may include additional processing including but not limited to: (1) object detection as disclosed in U.S. Pat. No. 8,855,375, filed Jan. 11, 2013; and U.S. Pat. No. 9,208,536, filed Sep. 19, 2014; U.S. patent application Ser. No. 14/927,359, filed Oct. 29, 2015; Ser. No. 15/234,969, filed Aug. 11, 2016 and Ser. No. 15/234,993, filed Aug. 11, 2016; (2) object classification as disclosed in U.S. Pat. No. 9,355,312, filed Mar. 13, 2013 and/or U.S. patent application Ser. No. 14/177,136, filed Feb. 10, 2014; (3) data extraction (optionally including binarization or thresholding as described in U.S. patent application Ser. No. 15/2314,351, filed Jul. 19, 2016 and Ser. No. 15/396,327, filed Dec. 30, 2016) as disclosed in U.S. Pat. No. 9,311,531, filed Mar. 13, 2015; and/or (4) data validation as disclosed in U.S. Pat. No. 8,345,981, filed Feb. 10, 2009; U.S. Pat. No. 8,774,981, filed Nov. 12, 2013; U.S. Pat. No. 8,958,605, filed Feb. 7, 2014; and U.S. patent application Ser. No. 14/804,278, filed Jul. 20, 2015.

One aspect of the embodiment of FIG. 4 includes the notion that the input comprises a plurality of the frames of digital video data. Processing the input includes one or more of several functions. For instance, processing the input may include transforming a representation of an object depicted in the plurality of frames of digital video data from a native object representation to an improved object representation, e.g. using a four-point algorithm to detect and transform objects using corner positions as described in U.S. Pat. No. 9,208,536, filed Sep. 19, 2014 or detect and transform objects using internal feature positions as described in U.S. patent application Ser. No. 14/927,359, filed Oct. 29, 2015; Ser. No. 15/234,969, filed Aug. 11, 2016 and Ser. No. 15/234,993, filed Aug. 11, 2016.

Further processing the processing result received from the image processing server may involve validating information extracted by the server and returned to the mobile device using a knowledge base not accessible to the image processing server. In this example, the processing result may be further processed without any further processing of the video data sent to the server or continuing to be captured by the mobile device.

In more approaches, further processing of the processing result may additionally and/or alternatively include extracting information from the video stream using the mobile device, but based on parameters determined from the image processing server's analysis of the video stream, such as using a particular OCR alphabet to extract information or recognize characters from a particular field known or expected to depict text fitting a particular type (e.g. alphabetic, alpha numeric, numeric-only, etc.) and/or format (e.g. date, social security number, address, etc. as would be appreciated by a person having ordinary skill in the art upon reading the present descriptions. These examples involve processing the video data captured by the mobile device.

Further processing in the context of operation 408 may, in various embodiments, involve further processing either or both of the foregoing sources of information. Moreover, the additional predetermined processing operations may be predefined by the user, or based on a predefined workflow (e.g. a process of extracting, from a video of a document, information necessary to complete a transaction and submitting such extracted information to an appropriate broker/system for completing the transaction).

Accordingly, the additional or further processing may include some or all of the processing functions performed by the server, which preferably may be performed using the mobile device and some guiding information included in the processing result received from the image processing server, such as object location within the video stream, characteristics of the object or portion(s) thereof (such as field locations, expected data type, format, etc.), instructions to improve captured video quality, etc. as would be understood by a person having ordinary skill in the art upon reading the present descriptions.

In some approaches, method 400 may include pre-processing the plurality of frames of digital video data prior to streaming the plurality of frames of digital video data to the server. For example, pre-processing may include determining a quality of the image, e.g. based on motion vectors estimated during the video capture operation which may indicate likelihood of blur or device movement, based on illumination characteristics of the image or capture device (e.g. flash setting), reducing resolution and/or color depth of the video data to reduce network bandwidth consumption and/or processing complexity, etc. as would be understood by a person having ordinary skill in the art upon reading the present descriptions. Notably, pre-processing the video frames must be accomplished in a manner so as not to interfere with real-time transmission and processing of such video frames using the image processing server.

The processing result preferably includes at least one of: an improved representation of an object depicted in the plurality of frames of digital video data, wherein the improved representation is generated by transforming at least some of the plurality of frames of digital video data from a native object representation to the improved representation of the object; a determination, from the plurality of frames of digital video data, of information of interest regarding the object; a classification of the object; extracted information of interest regarding the object; a validation status of some or all of the extracted information of interest; and feedback guiding the capture of additional frames of the digital video data.

Regarding feedback in particular, and from the exemplary scenario of a user capturing video of a document, a bounding rectangle may be displayed over the calculated position of the document (e.g. based on an immediately previous frame or a frame captured ˜ 1/10th seconds previous) and the user may be directed to move the capture device in a particular manner (e.g. by displaying indicators on the mobile device display such as a particular color of the box, arrow indicators, etc.) to improve the representation of the document within the video stream. This may improve the processing of subsequent frames using the new, guided capture conditions, and improve confidence in processing results, all in real-time and without requiring the user to engage in a manual capture operation.

As noted above, in various approaches streaming the video data may include streaming a plurality of successive ones of the plurality of frames of digital video data to the image processing server, or streaming a plurality of alternate ones of the plurality of frames, e.g. every other frame or every third frame, depending on frame rate.

To improve processing, in some instances the input may include more than simply the video data. As such, streaming the input may include comprising transmitting to the image processing server, in association with the streamed ones of the plurality of frames of digital video data (e.g. as metadata), additional data. These additional data may include any one or more of: identifying information corresponding to the mobile device; user-defined processing parameters; and location information corresponding to the mobile device, the one or more frames of digital video data, or both.

Accordingly, in various embodiments the one or more predetermined additional processing operations performed in operation 408 may include: capturing additional video frames depicting a tracked object in the video data, the capture of the additional video frames being characterized by a modification of capture conditions selected from illumination, capture angle, capture distance, and capture device movement; classifying an object whose location within the video data is indicated by the processing result received from the image processing server; extracting information of interest from select locations within the digital image, the select locations being based on the processing result received from the image processing server and the extraction employing extraction conditions based on the processing result received from the server; and/or validating information of interest extracted from the digital video data based on the processing result received from the image processing server, wherein the extracted information of interest are indicated in the processing result received from the image processing server.

With respect to capturing additional video data, in one approach the additional processing of the video data using the mobile device is useful for improving the quality of the video data, e.g. based on feedback from the server. For example, feedback may instruct the user to hold the device still, at a particular angle or position, etc. This may be accomplished in several approaches via the use of a bounding box displayed on the capture device viewfinder (e.g. based on the tracked object position determined by the server upon analyzing the streamed video) and appropriate instructions (e.g. arrows, textual or audible instructions such as “hold the device still,” “zoom in,” etc.) provided to the user via the mobile device.

In various embodiments, the tracked content may include the entirety of the object, or particular features of the object, such as internal features used for content-based detection and/or 3D reconstruction of image data, as described in U.S. patent application Ser. No. 15/234,969, filed Aug. 11, 2016 and Ser. No. 15/234,993, filed Aug. 11, 2016.

With respect to classification as part of additional processing, the server may determine the location of the object within the video stream, e.g. using corners, internal features, etc., and provide location information to the mobile device as the processing result. The mobile device may then define local search areas within the video data to improve the likelihood and quality of operations requiring knowledge regarding the object location, such as classification and extraction.

With respect to additional processing involving employing extraction conditions based on the processing result, in various approaches the extraction may be performed in a manner so as to improve accuracy and/or recall of information from the video data. For example, based on a classification of an object determined by the server and provided to the mobile device in the server's processing result, data extraction engines may be tuned so as to improve the extraction of particular information from particular locations within the document, e.g. a particular field may represent a subset of possible characters and thus a character recognition engine may exclude disallowed characters while extracting information from the field, thereby reducing the likelihood of extraction producing an erroneous result. Similarly, particular thresholding conditions suitable for a subregion of the video data characterized by a complex (e.g. “dual”) background may be defined for the mobile device's subsequent extraction processing.

With still further reference to additional processing by the mobile device and based on the server processing result, in one embodiment additional processing includes validating information of interest extracted from the digital video data based on the processing result received from the image processing server. For example, information may be extracted from the digital video, and a type or format of the extracted information may be determined. Based on the type or format, an appropriate authority (e.g. a secure, curated knowledge base) for validation may be determined. In a concrete implementation, a social security number may be validated using a database of social security numbers registered with the appropriate government agency. In such embodiments, preferably the extracted information of interest are indicated in the processing result received from the image processing server.

These processing conditions may be determined based in part, according to several embodiments, on an object classification. For instance, the server may classify the object, and return to the mobile device an object class from which the mobile device may retrieve associated object characteristics from a locally-stored knowledge base.

While the present descriptions of data extraction within the scope of the instant disclosure have been made with primary reference to methods, one having ordinary skill in the art will appreciate that the inventive concepts described herein may be equally implemented in or as a system and/or computer program product.

For example, a system within the scope of the present descriptions may include a processor and logic in and/or executable by the processor to cause the processor to perform steps of a method as described herein.

Similarly, a computer program product within the scope of the present descriptions may include a computer readable storage medium having program code embodied therewith, the program code readable/executable by a processor to cause the processor to perform steps of a method as described herein.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

Accordingly, one embodiment of the present invention includes all of the features disclosed herein, including those shown and described in conjunction with any of the FIGS. Other embodiments include subsets of the features disclosed herein and/or shown and described in conjunction with any of the FIGS. Such features, or subsets thereof, may be combined in any way using known techniques that would become apparent to one skilled in the art after reading the present description.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An image processing server, comprising at least one processor, and logic configured, upon execution thereof by the processor, to cause the server to:
process, in real time, input streamed to the server from a mobile device, the input comprising one or more frames of digital video data; and
output a result of processing the input to the mobile device.

2. The image processing server as recited in claim 1, wherein the input comprises a plurality of the one or more frames of digital video data, and processing the input comprises at least one of:
transforming a representation of an object depicted in the plurality of frames of digital video data from a native object representation to an improved object representation;
determining information of interest regarding the object from the plurality of frames of digital video data;
classifying the object depicted in the plurality of frames of digital video data;
extracting the information of interest regarding the object from the plurality of frames of digital video data; and
validating the information of interest extracted from the plurality of frames of digital video data.

3. The image processing server as recited in claim 1, wherein the input further comprises at least one of:
identifying information corresponding to the mobile device;
user-defined processing parameters; and
location information corresponding to the mobile device, the one or more frames of digital video data, or both; and
wherein processing the input comprises processing the one or more frames of digital video data further based at least in part on the identifying information, the user-defined processing parameters, or the location information.

4. The image processing server as recited in claim 1, wherein the logic is configured to cause the server to process each one of the one or more frames of the digital video data streamed to the server in real-time or near real-time.

5. The image processing server as recited in claim 1, comprising calculating a consensus processing result from among a plurality of processing results each respectively corresponding to one of the one or more frames of digital video data.

6. The image processing server as recited in claim 1, wherein the input comprises a plurality of successive ones of the one or more frames of digital video data.

7. The image processing server as recited in claim 1, wherein the input comprises a plurality of alternating ones of the one or more frames of digital video data.

8. A computer-implemented method, comprising:
capturing, using a camera of a mobile device, a plurality of frames of digital video data;
streaming at least some of the plurality of frames of digital video data to an image processing server configured to process frames of digital video data in real-time;
receiving, from the image processing server, a processing result corresponding to some or all of the plurality of frames of digital video data streamed to the image processing server; and
further processing, using a processor of the mobile device, according to one or more predetermined additional processing operations, some or all of the plurality of frames of digital video data captured using the camera of the mobile device, the processing result received from the image processing server, or both.

9. The computer-implemented method as recited in claim 8, further comprising pre-processing the plurality of frames of digital video data prior to streaming the plurality of frames of digital video data to the image processing server.

10. The computer-implemented method as recited in claim 8, wherein the processing result comprises at least one of:
an improved representation of an object depicted in the plurality of frames of digital video data, wherein the improved representation is generated by transforming at least some of the plurality of frames of digital video data from a native object representation to the improved representation of the object;
a determination, from the plurality of frames of digital video data, of information of interest regarding the object;
a classification of the object;
extracted information of interest regarding the object;
a validation status of some or all of the extracted information of interest; and
feedback guiding the capture of additional frames of the digital video data.

11. The computer-implemented method as recited in claim 8, wherein the streaming comprises streaming a plurality of successive ones of the plurality of frames of digital video data to the image processing server.

12. The computer-implemented method as recited in claim 8, wherein the streaming comprises either: streaming a plurality of alternate ones of the plurality of frames of digital video data to the image processing server; streaming a limited number of the plurality of frames of digital video data to the image processing server; or both.

13. The computer-implemented method as recited in claim 8, further comprising transmitting to the image processing server, in association with the streamed ones of the plurality of frames of digital video data, one or more of:
identifying information corresponding to the mobile device;
user-defined processing parameters; and
location information corresponding to the mobile device, the one or more frames of digital video data, or both.

14. The computer-implemented method as recited in claim 8, wherein the one or more predetermined additional processing operations are selected from:
capturing additional video frames depicting a tracked object in the video data, the capture of the additional video frames being characterized by a modification of capture conditions selected from illumination, capture angle, capture distance, and capture device movement;
classifying an object whose location within the video data is indicated by the processing result received from the image processing server;
extracting information of interest from select locations within one or more frames of the digital video data, the select locations being based on the processing result received from the image processing server and the extraction employing extraction conditions based on the processing result received from the server; and
validating information of interest extracted from the digital video data based on the processing result received from the image processing server, wherein the extracted information of interest are indicated in the processing result received from the image processing server.

15. The computer-implemented method as recited in claim 14, wherein the processing result received from the image processing server comprises a consensus processing result.

16. A computer program product, comprising a computer readable medium having embodied therewith computer readable program code configured, upon execution thereof, to cause a mobile device to perform operations comprising:
capturing, using a camera of the mobile device, a plurality of frames of digital video data;
streaming at least some of the plurality of frames of digital video data to an image processing server configured to process frames of digital video data in real-time;
receiving, from the image processing server, a processing result corresponding to some or all of the plurality of frames of digital video data streamed to the image processing server; and
further processing, using a processor of the mobile device and according to one or more predetermined additional processing operations, some or all of the plurality of frames of digital video data captured using the camera of the mobile device, the processing result received from the image processing server, or both.

17. The computer program product as recited in claim 16, further comprising computer readable program code configured, upon execution thereof, to cause a mobile device to pre-process the plurality of frames of digital video data prior to streaming the plurality of frames of digital video data to the image processing server.

18. The computer program product as recited in claim 16, wherein the processing result comprises at least one of:
an improved representation of an object depicted in the plurality of frames of digital video data, wherein the improved representation is generated by transforming at least some of the plurality of frames of digital video data from a native object representation to the improved representation of the object;
a determination, from the plurality of frames of digital video data, of information of interest regarding the object;
a classification of the object;
extracted information of interest regarding the object;
a validation status of some or all of the extracted information of interest; and
feedback guiding the capture of additional frames of the digital video data.

19. The computer program product as recited in claim 16, wherein the one or more predetermined additional processing operations are selected from:
capturing additional video frames depicting a tracked object in the video data, the capture of the additional video frames being characterized by a modification of capture conditions selected from illumination, capture angle, capture distance, and capture device movement;
classifying an object whose location within the video data is indicated by the processing result received from the image processing server;
extracting information of interest from select locations within one or more frames of the digital video data, the select locations being based on the processing result received from the image processing server and the extraction employing extraction conditions based on the processing result received from the server; and
validating information of interest extracted from the digital video data based on the processing result received from the image processing server, wherein the extracted information of interest are indicated in the processing result received from the image processing server.

20. The computer program product as recited in claim 19, wherein the processing result received from the image processing server comprises a consensus processing result.
